(19) United States
(12) Patent Application Publication
(10) Pub. No.: US 2003/0066660 A1
(43) Pub. Date: Apr. 10, 2003

(54) Fire suppression device

(76) Inventors: Simon Howard Horwell, East Sussex (GB); Terence Michael Egan, Surrey (GB)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/264,320

(22) Filed: Oct. 3, 2002

(30) Foreign Application Priority Data
Oct. 4, 2001 (GB) 0123859.1

(51) Int. Cl. A62C 8/00

(52) U.S. Cl. 169/50; 169/49; 169/48; 169/36

(57) ABSTRACT

A fire suppression assembly comprising a blanket and a packet securely attached to the blanket near the centre by means of an adhesive. The blanket is a standard fire blanket and the packet comprises a housing made from a heat-sealed high density polyethylene, containing a fire suppressing formulation.

### TECHNICAL FIELD

The present invention relates to a device for the suppression of fire, in particular, fires occurring in deep fat fryers, such as those used in commercial kitchens.

### BACKGROUND ART

An increased awareness of fire safety issues and increasing legislation has necessitated the installation of hand portable fire fighting equipment in kitchens. This typically consists of hand portable fire extinguishers and fire blankets. Of the types of fire extinguisher that may be deployed in kitchens, all have certain disadvantages, which can be outlined as follows.

A source of carbon dioxide is often used but it has the disadvantage that although it is clean, it does not cool the fat or oil sufficiently and re-ignition is almost inevitable. Dry powder is commonly used and is very effective, but the mess and contamination problems it causes are disproportionate and results in excessive down time and financial loss associated with loss of business hours and contaminated food.

Foam-type extinguishers can also be used but their use is restricted to operators who are trained and experienced in their use. Furthermore, even if applied to a deep fat fire correctly, they can react violently and place the operator at serious risks of burns. A special class of extinguishers have been developed for fires involving cooking oils and fats in depth called Class “F” Units. These have numerous disadvantages including their high cost, irritant fumes and difficulty of use. Fire blankets are a standard means of fighting fires in kitchens, especially those involving deep fat fires. They are seldom used however due to the danger involved in trying to smother fat fires and the fact that any part of the blanket which sags and dips into the fat can become a wick and so cause re-ignition.

### SUMMARY OF THE INVENTION

The present invention addresses these problems and presents a solution for the safe and efficient suppression of fires occurring in deep fat fryers. The principle of the present invention is the application of the fire suppressant chemical or formulation directly to the burning fat/oil, without the use of pressure or spray devices.

According to the present invention, therefore, a fire suppressant device comprises a rupturable container or packet containing a fire suppressant in the form of a chemical or formulation which, when applied to the burning fat or oil, is arranged to rupture thereby releasing the fire suppressant on to the surface or sub-surface of the burning fat/oil.

The invention may be carried into practice in various ways and one embodiment will now be described by way of example with reference to the accompanying drawings, in which:

### BRIEF DESCRIPTION OF THE DRAWINGS

FIG. 1 is an isometric sketch of a blanket and packet of fire suppressant in accordance with the invention; and

FIG. 2 is a section on the line A-A in FIG. 1.

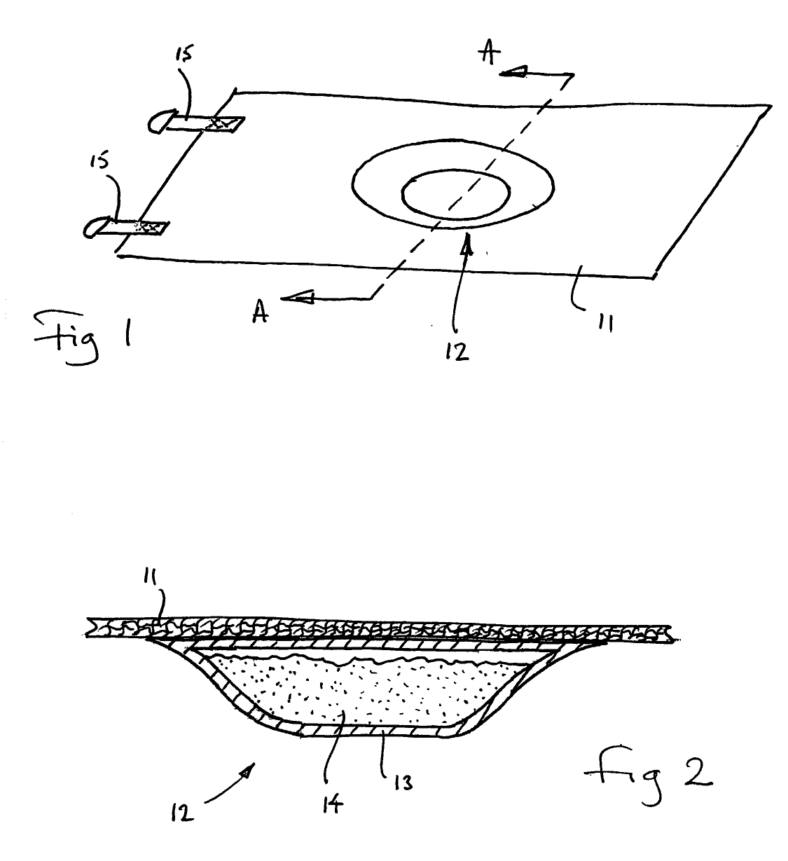

### DETAILED DESCRIPTION OF THE DRAWINGS

The fire suppression device comprises a blanket 11 and a packet 12 securely attached to the blanket 11, near the centre by means of an adhesive. The blanket 11 is a standard fire suppressing blanket made from a non-flammable material, such as glass fibre.

The packet 12 comprises a housing 13 made from a heat-sealed high density polyethylene. The housing contains a fire suppressing formulation in the form of a free flowing silicone-treated powder 14, the powder itself comprising sodium or potassium bicarbonate. Alternatively, the formulation could be in liquid form, rather than in powder form. The blanket 11 has a pair of release tabs 15.

Normally, the blanket 11 would be folded up around the packet 12 and stored in a suitable conveniently located dispenser (not shown). In use, in the case of a fire in a deep fat fryer, the blanket 11 is removed from the dispenser using the tabs 15 and placed over the fire so that the packet 12 is directly in or on the fire. The fire melts the container 13 and the fire-suppressing powder 14 reacts with the oil to form a foam covering over the surface of the oil.

The packet is preferably made of a polymer or polymer/foil composite, or any suitable material according to the packets contents in terms of material compatibility and heat reaction. It has been found that high-density polyethylene packets are best suited which have been sealed by heat, adhesive or a clamp. The fire suppressant substances within the packets may be solids, powders, liquids or gels. Such fire suppressants are usually formulations containing chemicals, which react with the hot fat to form a foam blanket on the surface of the fat, usually by saponification.

Among suitable liquid formulations, water-based solutions of alkali carbonates, hydroxides, acetates, citrates, taratates or other reagents capable of saponification reaction with fats and oils are generally the most effective. Detergents may also be added to aid dispersion and it has been found convenient to gel the liquids or viscosify them to make the packets easier to apply. Viscosified or gelled liquids also tend to react with the hot fat/oil in a more controlled manor, adding to user safety.

Solids, particularly powders can also be used as the fire suppressant medium. It has been found that free flowing silicone-treated powders are the most effective, using solid forms of the chemicals used in the liquid formulation. Conveniently, existing commercial fire fighting dry powders, especially those based on sodium or potassium bicarbonates, are ideal for use in this application.

Applying a packet of material by hand to a vat of burning fat or oil would be highly hazardous to the operator and therefore it is a further object of the invention to provide a means of delivering the packet of fire suppressant to the fire, with minimum risk to the operator.

One way of doing this is by using a rigid applicator similar to a spade, where the packet of material is manually “dumped” into the vat of oil. Such an applicator however is impractical and clumsy in real life situations.

A preferred method of applying the packet to the fires is by attaching the packet to a blanket, preferably by incorporating the packet in a standard fire blanket. The packet of material is secured to the centre of the blanket by suitable means, and the blanket is then refolded and packed into a container. In the case of a fire, the blanket incorporating the bag is applied to the burning fry vat in the normal way. Upon doing so, the fire is initially smothered by the action of the blanket, then the heat or the hot oil/fat melts the packet releasing the suppressant chemical on to the surface.

This approach also greatly reduces the dangers associated with applying the blanket, as time does not have to be wasted ensuring a good seal which would normally be desirable to keep air away from the fire. Even if a good seal is not achieved, using the system of the present invention, the packet will ensure suppression when the suppressant is released.

It will be obvious to those skilled in the art that other embodiments in addition to the ones described herein are indicated to be within the scope and breadth of the present application. Accordingly, the applicant intends to be limited only by the claims appended hereto.

1. A fire suppressant assembly comprising a fire blanket and a fire suppressant device attached to the blanket, the fire suppressant device comprising a rupturable container and a fire suppressant material contained within the rupturable container, the rupturable container being constructed and arranged to rupture when applied to a fire, thereby releasing the fire suppressant material onto the fire.

2. An assembly according to claim 1, wherein the container is made of a polymer.

3. An assembly according to claim 1, wherein the container is made from a polymer/foil composite.

4. An assembly according to claim 1, wherein the container is made from high-density polyethylene.

5. An assembly according to claim 1, wherein the fire suppressant material is a formulation containing chemicals which react with hot oil to form a foam blanket on the surface of the oil.

6. An assembly according to claim 1, wherein the fire suppressant material is a liquid formulation in the form of a water-based solution selected from the group consisting of alkali carbonates, hydroxides, acetates, citrates, tartarates and other reagents capable of a saponification reaction with oils.

7. An assembly according to claim 1, wherein a detergent is included in the container with the fire suppressant.

8. An assembly according to claim 6, wherein the liquid formulation is gelled.

9. An assembly according to claim 1, wherein the fire suppressant material is a solid powder selected from the group consisting of alkali carbonates, hydroxides, acetates, citrates, tartarates and other reagents capable of a saponification reaction with oils.

10. An assembly according to claim 9, wherein the powder is a free-flowing silicone-treated powder.

11. An assembly according to claim 9, wherein the powder is selected from the group consisting of sodium bicarbonate and potassium bicarbonate.

12. An assembly according to claim 1, wherein the container is secured to the centre of the blanket and the blanket is folded around the container.

13. A fire suppressant device comprising a rupturable container and a fire suppressant material contained within the rupturable container, the rupturable container being constructed and arranged to rupture when applied to a fire thereby releasing the fire suppressant material onto the fire.

14. A device according to claim 13, wherein the container is made of a polymer or polymer/foil composite.

15. A device according to claim 13, wherein the container is made from a polymer/foil composite.

16. A device according to claim 13 wherein the container is made from high-density polyethylene.

17. A device according to claim 13, wherein the fire suppressant material is a formulation containing chemicals which react with hot fat to form a blanket on the surface of the fat.

18. A device according to claim 13, wherein the fire suppressant material is a liquid formulation in the form of a water-based solution selected from the group consisting of alkali carbonates, hydroxides, acetates, citrates, tartarates and other reagents capable of a saponification reaction with oils.

19. A device according to claim 13, wherein a detergent is included in the container with the fire suppressant.

20. A device according to claim 19, wherein the liquid formulation is gelled.

21. A device according to claim 13, wherein the fire suppressant material is a solid powder selected from the group consisting of alkali carbonates, hydroxides, acetates, citrates, tartarates and other reagents capable of a saponification reaction with oils.

22. A device according to claim 21, wherein the powder is a free-flowing silicone-treated powder.

23. A device according to claim 21, wherein the powder is selected from the group consisting of sodium bicarbonate and potassium bicarbonate.
